(19) United States
(12) Patent Application Publication
(10) Pub. No.: US 2019/0303928 A1
(43) Pub. Date: Oct. 3, 2019

(54) USER AUTHENTICATION IN TRANSACTIONS

(71) Applicant: CA, Inc., Slandia, NY (US)

(72) Inventors: Mohammed Mujeeb Kaladgi, Bangalore (IN); Ruqiya Nikhat Kaladgi, Bangalore (IN); Yashwant Ramkishan Sawant, Maharastra (IN); Sandeep Banisetti, Andhra Pradesh (IN)

(73) Assignee: CA, Inc., Islandia, NY (US)

(21) Appl. No.: 15/940,955

(22) Filed: Mar. 29, 2018

(51) Int. Cl. G06Q 20/38; H04L 9/32; G06Q 20/40; G06Q 20/20; G06Q 20/32

(52) U.S. Cl. CPC G06Q 20/3829; H04L 9/3271; H04L 9/3231; G06Q 2220/00; G06Q 20/202; G06Q 20/3278; G06Q 20/40145

(57) ABSTRACT

According to one aspect of the present disclosure, a payment initiation request is received at a point of sale (POS) device from a user device. A challenge string stored at the POS device is transmitted from the POS device to the user device based on the payment initiation request. Payment information and a signed version of the particular challenge string are received at the POS device from the user device. The signed version of the particular challenge string is based on a private key associated with the user device and the particular challenge string. An authentication request including the signed version of the particular challenge string is transmitted from the POS device to a server device. An indication of whether the user device is authenticated is received at the POS device, from the server device, based on the authentication request, and a payment protocol is executed using the payment information.

### BACKGROUND

The present disclosure relates in general to the field of user authentication, and more specifically, to user authentication in transactions.

Certain protocols may use public key cryptography techniques for user authentication. As one example, the Fast ID Online (FIDO) protocol uses a public/private key pair to authenticate users. A private key may be stored on a user device and a public key may be stored on a server device. The private key on the user device may be accessed through biometric verification and used to authenticate the user at a later time.

### BRIEF SUMMARY

According to one aspect of the present disclosure, a payment initiation request may be received at a point of sale (POS) device from a user device. A challenge string stored at the POS device may be transmitted from the POS device to the user device based on the payment initiation request. Payment information and a signed version of the particular challenge string may be received at the POS device from the user device. The signed version of the particular challenge string may be based on a private key associated with the user device and the particular challenge string. An authentication request including the signed version of the particular challenge string may be transmitted from the POS device to a server device, and an indication of whether the user device is authenticated may be received at the POS device, from the server device, based on the authentication request. A payment protocol may be executed using the payment information based on the indication received.

### BRIEF DESCRIPTION OF THE DRAWINGS

FIG. 1A illustrates an example environment for authenticating a user device at a point of sale (POS) device based on challenge strings.

FIG. 1B simplified block diagrams of the example user device, POS device, and authentication server of FIG. 1A.

FIG. 2 illustrates an example signaling sequence for generating a public-private key pair for use in authentication processes.

FIG. 3 illustrates an example signaling sequence for storing challenge strings on a POS device.

FIG. 4 illustrates an example signaling sequence for performing user authentication based on challenge strings.

FIG. 5 is a flowchart illustrating an example process for signing a challenge string issued by a POS device.

FIG. 6 is a flowchart illustrating an example process for performing a transaction at a POS device based on challenge strings.

FIG. 7 is a flowchart illustrating an example process for authenticating a user based on signed challenge strings.

Like reference numbers and designations in the various drawings indicate like elements.

### DETAILED DESCRIPTION

As will be appreciated by one skilled in the art, aspects of the present disclosure may be illustrated and described herein in any of a number of patentable classes or contexts, including any new and useful process, machine, manufacture, or composition of matter, or any new and useful improvement thereof. Accordingly, aspects of the present disclosure may be implemented entirely as hardware, entirely as software (including firmware, resident software, micro-code, etc.), or as a combination of software and hardware implementations, all of which may generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain or store a program for use by, or in connection with, an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, CII, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider), or in a cloud computing environment, or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses, or other devices, to produce a computer implemented process such that the instructions which execute on the computer or other programmable apparatus provide processes for implementing the functions/acts specified in the flowchart and/or block diagram block or blocks.

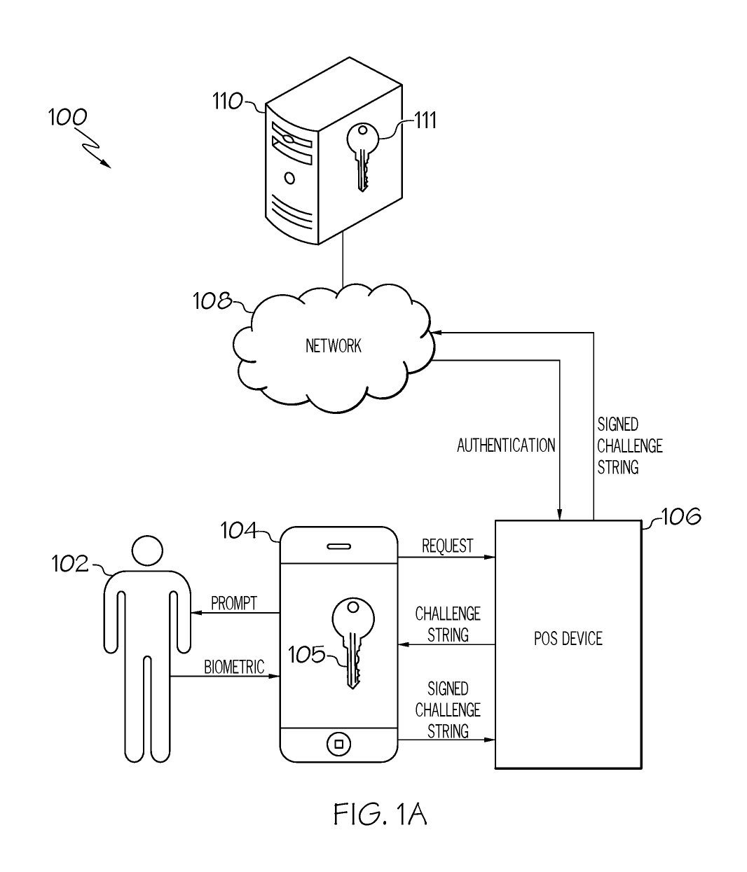

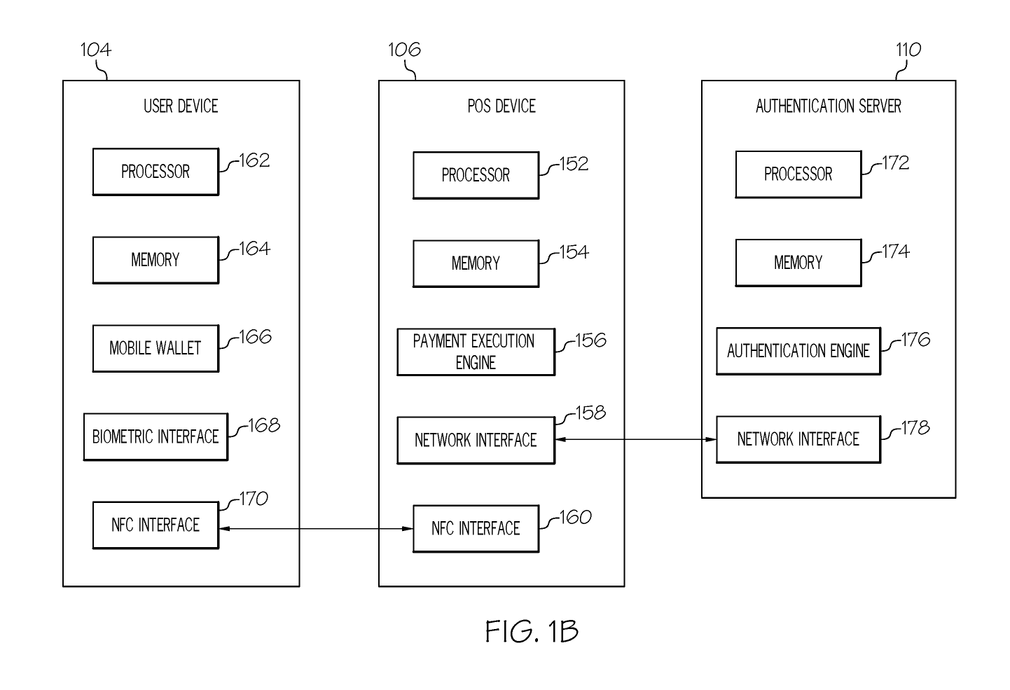

FIG. 1A illustrates an example environment 100 for authenticating a user device 104 at a point of sale (POS) device 106 based on challenge strings. The user device 104 may be any suitable computing device and may include a processor, memory, or other hardware components. For instance, the example user device 104 shown in FIG. 1A is a smartphone. However, another type of device may be used as a user device 104 without departing from the scope of the present disclosure. The user device 104 may have software, hardware, or a combination thereof that allows the user 102 to initiate a transaction with the POS device 106. For example, the user device 104 may have a near field communication (NFC) chipset that is used in conjunction with a “mobile wallet” application installed on the user device 104 to initiate a transaction with the POS device 106. The POS device 106 may be any suitable device used to execute a transaction (e.g., process a credit or debit card payment), and may include a processor, memory, or other hardware components. The POS device 106 may have software, hardware, or a combination thereof that allows the POS device 106 to execute the transaction. For example, the POS device 106 may run application-specific software for processing payment information, and may include certain interfaces for performing the same.

In the example shown, the user 102 is initiating a transaction with the POS device 106 using the user device 104. To initiate the transaction, the user device 104 sends a transaction initiation request to the POS device 106, and in response, the POS device 106 provides a challenge string to the user device 104. The POS device 106 may delete the challenge string from memory after sending to the user device 104 (reducing the total number of challenge strings stored on the POS device 106). The user device 104 prompts the user 102 to input a biometric (e.g., a fingerprint or other type of biometric) to the user device 104. If the biometric is validated by the user device 104, the user device 104 accesses a private key 105 stored thereon and uses the private key 105 to sign the challenge string. In some embodiments, signing the challenge string may be based on encrypting the challenge string using the private key 105. For example, the private key 105 and challenge string may be input to an encryption function, and the output of the encryption function may be a signed version of the challenge string. The user device 104 then returns the signed version of the challenge string to the POS device 106. Other information may be sent to the POS device 106 by the user device 104 as well, such as payment information or other types of transaction information. For example, the user device 104 may send credit card information along with the signed version of the challenge string. The user device 104 may send the payment information at another time as well.

The POS device 106 transmits the signed version of the challenge string to an authentication server 110 over the network 108. The network 108 may include one or more networks of different types, including, for example, local area networks, wide area networks, public networks, the Internet, cellular networks, Wi-Fi networks, short-range networks (e.g., Bluetooth or ZigBee), and/or any other wired or wireless communication medium. In some cases, the network 108 includes the Internet. The POS device 106 may transmit additional information to the server 110 as well, such as payment information (e.g., bank account information or credit card information).

The authentication server 110 authenticates the signed version of the challenge string using a public key 111 associated with the private key 105 used by the user device 104 to sign the challenge string. In some embodiments, authenticating the signed version of the challenge string may be based on decrypting the signed version of the challenge string using the public key 111. If the challenge string is authenticated by the authentications server 110, then a payment protocol is executed using payment information. For example, the authentication server 110 may validate funds associated with payment information provided by the POS device 106. As another example, the POS device 106 may transmit the payment information to another server, which may in turn validate funds associated with the payment information provided by the POS device 106. If the authentication server 110 fails to authenticate the signed version of the challenge string, then it may return a failure message to the POS device 106, and the transaction may not be executed.

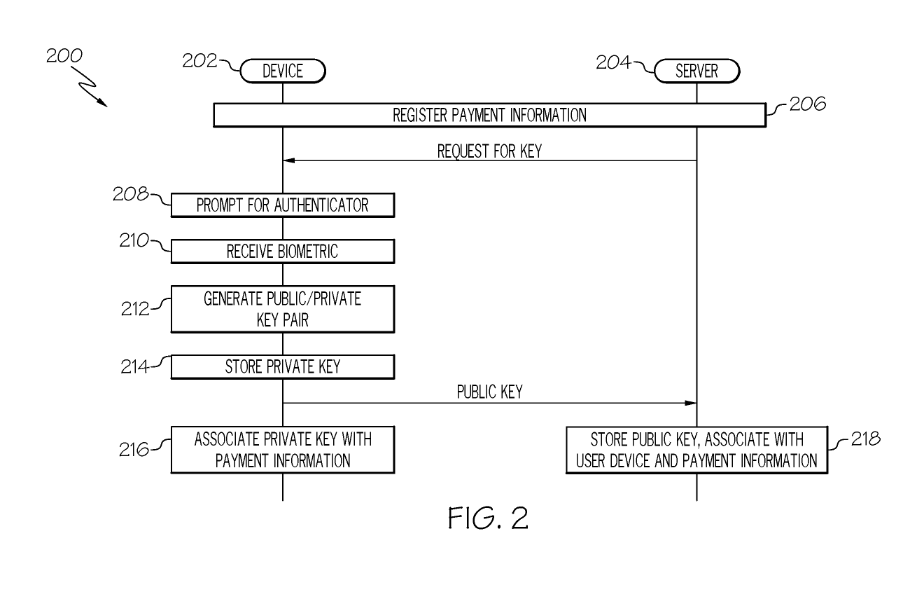

In some embodiments, the public/private key pair are generated according to the Fast ID Online (FIDO) protocol. For example, the user 102 may (e.g., prior to initiating transactions as described above) register the user device 104 with the authentication server 110 for a payment provider in order to obtain the public/private key pair. During the registration process, the user 102 may be prompted to enter a biometric or another type of authentication factor (e.g., two-factor authenticator, a PIN, or another type of authenticator) at the user device 104. The user device 104 may generate the public/private key pair, store the private key on the user device 104, and associate the private key with the biometric (or another authentication factor). The public/private key pair may be unique to the user device 104 and the account of the user 102 (e.g., not shared with another type of payment method). The user device 104 sends the public key to the authentication server 110, where it is stored and associated with the user's account. In some instances, the public/private key pair is generated in accordance with the sequence 200 described below with respect to FIG. 2.

The authentication server 110 may know which public key to use in the authentication process based on a user device identifier that is transmitted along with the signed challenge string. For example, the POS device 106 may generate an ISO 8583 packet that includes an identifier for the user device 104, an identifier for the POS device 106, payment information, or other information related to a transaction.

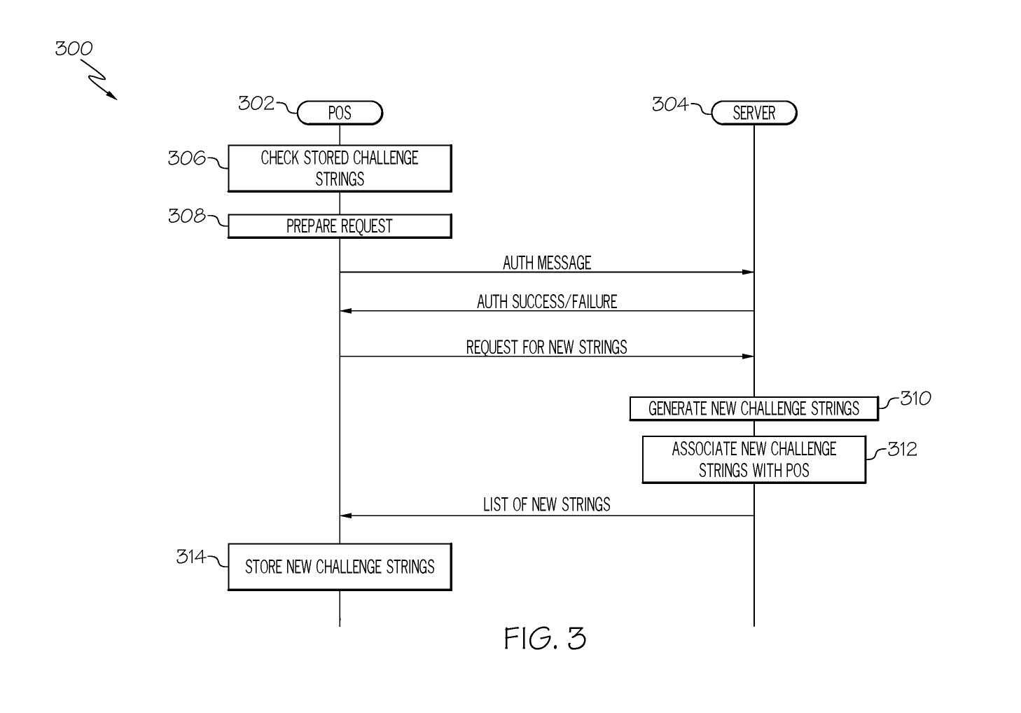

In some embodiments, the POS device 106 may store a plurality of challenge strings at a time. The challenge strings may be issued by the authentication server 110, or another server. The challenge strings may be uniquely associated with the POS device 106 in some instances. Further, in some cases, the challenge strings stored at the POS device 106 may be associated with a particular sequence. The authentication server 110 may, during the challenge string authentication process, authenticate the POS device 106 by verifying that the challenge string sent by the POS device 106 is associated with the POS device 106. In addition, the authentication server 110 may, during the challenge string authentication process, verify that the challenge string sent by the POS device 106 is also the correct challenge string according to a predetermined sequence (i.e., that the challenge string was properly issued to the user device 104 according to the predetermined sequence). In some instances, the challenge strings are generated and stored in accordance with the sequence 300 described below with respect to FIG. 3.

FIG. 1B illustrates simplified block diagrams of the example user device 104, POS device 106, and authentication server 110 of FIG. 1A. In the example shown, the POS device 106 includes a processor 152, memory 154, a payment execution engine 156, a network interface 158, and a NFC interface 160. The example processor 152 executes instructions to perform one or more of the operations described herein (e.g., process payment initiation requests or execute transactions). The instructions can include programs, codes, scripts, or other types of data stored in a memory. Additionally, or alternatively, the instructions can be encoded as pre-programmed or re-programmable logic circuits, logic gates, or other types of hardware or firmware components. The processor 152 may be or include a general-purpose microprocessor, as a specialized co-processor or another type of data processing apparatus. In some cases, the processor 152 may be configured to execute or interpret software, scripts, programs, functions, executables, or other instructions stored in the memory 154. In some instances, the processor 152 includes multiple processors or data processing apparatuses.

The example memory 154 includes one or more computer-readable media. For example, the memory 154 may include a volatile memory device, a non-volatile memory device, or a combination thereof. The memory 154 can include one or more read-only memory devices, random-access memory devices, buffer memory devices, or a combination of these and other types of memory devices. The memory 154 may store instructions that are executable by the processor 152 to perform one or more operations described herein.

The example network interface 158 provides communication between the POS device 106 and one or more other devices connected to the network 108 (e.g., authentication server 110 as shown). The network interface 158 may include a wireless interface or a wired interface for communication over the network 108. The network interface 158 may include another type of interface.

The example NFC interface 160 provides communication between the POS device 106 and one or more mobile devices (e.g., the user device 104 as shown) that are in close proximity to the POS device 106. The NFC interface 160 may include a radio frequency (e.g., 13.56 MHz) interface for one- or two-way information exchange with the mobile devices. In some instances, the NFC interface 160 is capable of communication according to one or more standards, such as ISO/IEC 18092/ECMA-340—Near Field Communication Interface and Protocol-1 (NFCIP-1) or ISO/IEC 21481/ECMA-352—Near Field Communication Interface and Protocol-2 (NFCIP-2).

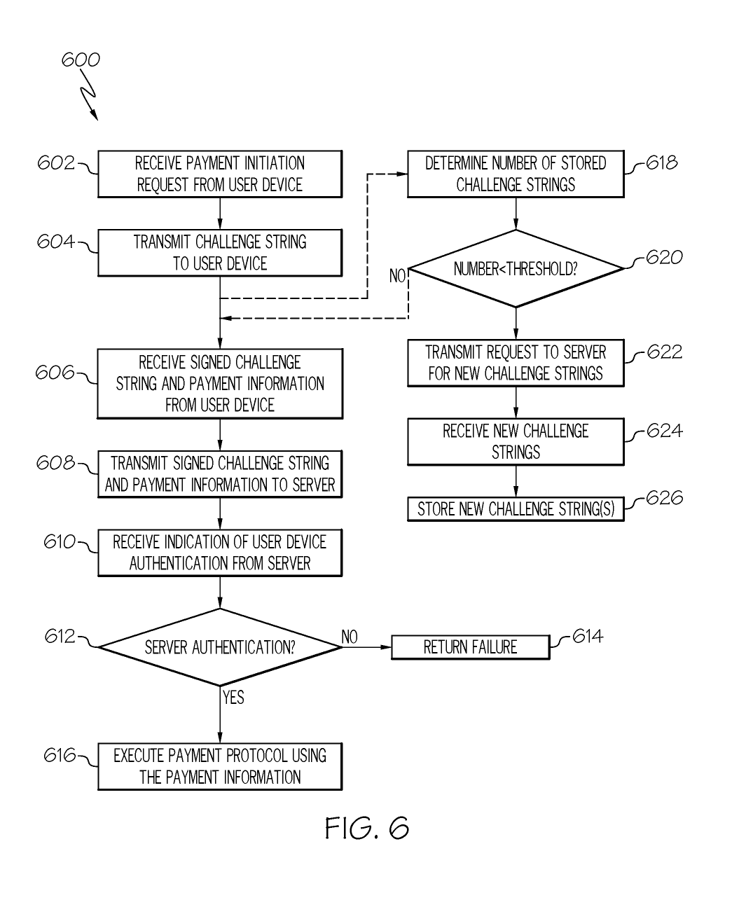

The example payment execution engine 156 includes instructions for processing payment initiation requests, executing payment protocols, or both. The instructions of the payment execution engine 156 may be provided to the processor 154 for execution. The payment execution engine may be implemented as software, firmware, hardware, or a combination thereof. The payment execution engine 156 may include instructions to perform one or more of the operations described below, such as, for example, the operations described below with respect to the process 600 of FIG. 6. The payment execution engine 156 may include additional instructions as well.

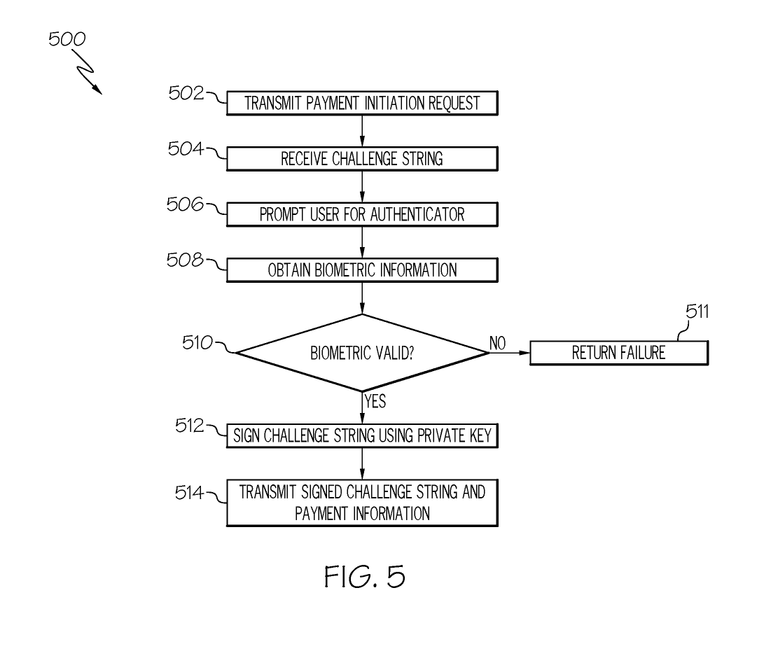

In the example shown, the user device 104 includes a processor 162, memory 164, a mobile wallet 166, a biometric interface 168, and a NFC interface 170. The processor 162 and memory 164 may be implemented similar to the processor 152 and memory 154, respectively. The NFC interface 170 may be implemented similar to the NFC interface 160. As shown, the NFC interface 170 may communicate with the NFC interface 160 (or another NFC interface) over a NFC communication channel. The mobile wallet 166 includes payment information, one or more private keys, and instructions (executable by the processor 162) for initiating a transaction using the payment information and private keys stored therein. The mobile wallet 166 may be implemented as software, firmware, hardware, or a combination thereof. The mobile wallet 166 may include instructions to perform one or more of the operations described below, such as, for example, the operations described below with respect to the process 500 of FIG. 5. The biometric interface 168 includes an interface for obtaining biometric information from a user of the user device 104. The biometric interface may be implemented as software, firmware, hardware, or a combination thereof. In some instances, the biometric interface 168 includes a fingerprint reader.

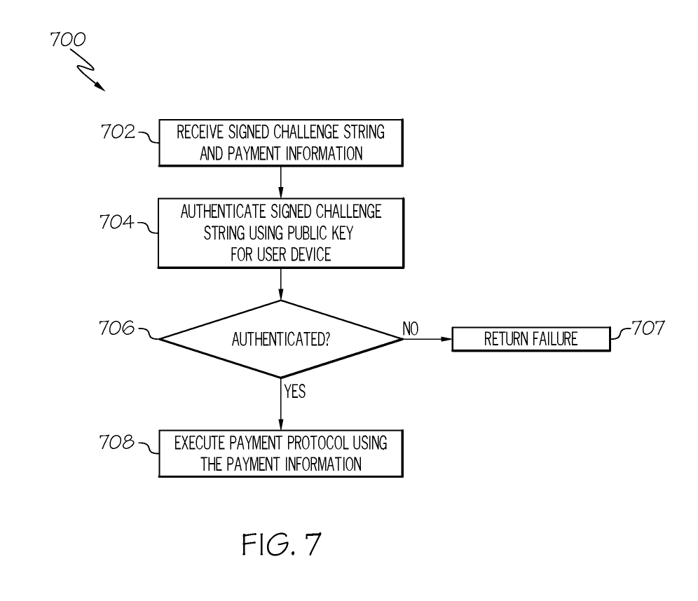

In the example shown, the authentication server 110 includes a processor 172, memory 174, an authentication engine 176, and a network interface 178. The processor 172 and memory 174 may be implemented similar to the processor 152 and memory 154, respectively. The network interface 178 may be implemented similar to the network interface 158. As shown, the network interface 178 may communicate with the network interface 158 (over a network, e.g., the network 108 of FIG. 1A). The authentication engine 176 includes instructions (executable by the processor 172) for authenticating signed versions of challenge strings sent to the POS device 106 by the user device 104, executing a payment protocol, or both. The authentication engine 176 may be implemented as software, firmware, hardware, or a combination thereof. The authentication engine 176 may include instructions to perform one or more of the operations described below, such as, for example, the operations described below with respect to the process 700 of FIG. 7.

FIG. 2 illustrates an example signaling sequence 200 for generating a public-private key pair for use in authentication processes. The example sequence 200 involves a user device 202 and a server 204. The user device 202 may be any type of device that can initiate transactions with a POS device. For instance, the user device 202 may be a smartphone (like user device 104 of FIG. 1A), a wearable device, a tablet device, or another type of mobile computing device. The server 204 may be an authentication server, such as the authentication server 110 of FIG. 1A, or another type of server. The sequence 200 may include additional or fewer operations than those shown in FIG. 2, and may involve additional devices or servers as appropriate. In some instances, the sequence 200 may generated a public/private key pair in accordance with the FIDO protocol.

In the example shown, a user of the user device 202 first registers their payment information with the server 204 at 206. Registering the user account may include logging into the server 204 and associating certain payment information (e.g., credit card, debit card, or bank account information) with a user account. The user account may be created at 206, or may have been created previously. After the payment information is registered at 206, the server 204 sends a request for a public key to the user device 202. In response, the user device 202 prompts the user for an authenticator (e.g., a biometric) at 208, and receives a biometric (e.g., a fingerprint) as input at 210. The device 202 then generates a public/private key pair at 212, and stores the private key at 214. The private key 214 may be associated with the biometric by the user device 202, such that the private key may be accessed only after a newly received biometric (e.g., in a user device authentication session) has been verified against the biometric received at 210. The user device 202 then sends the public key to the server 204, and associates the private key with the payment information at 216 (e.g., so the particular private key is used to sign challenge strings during a transaction when the particular payment information is selected by the user). The server 204 stores the public key received from the user device 202 and associates the public key with the payment information registered at 206 and the user device 202 at 218.

FIG. 3 illustrates an example signaling sequence 300 for storing challenge strings on a POS device 302. The example sequence 300 involves a POS device 302 and a server 304. The POS device 302 may be any type of device that can process payment initiation requests from a user device (e.g., the user device 104 of FIG. 1A) and execute transactions based on the payment initiation requests. The server 204 may be an authentication server, such as the authentication server 110 of FIG. 1A, or another type of server. The sequence 300 may include additional or fewer operations than those shown in FIG. 3, and may involve additional devices or servers as appropriate. In some instances, the sequence 300 may be used to initialize the POS device 302 with a first set of challenge strings.

In the example shown, the POS device 302 checks the challenge strings stored thereon at 306. Checking the challenge strings may include determining whether there are at least a threshold number of challenge strings stored on the POS device 302. For example, the POS device 302 may determine that it has a number of challenge strings stored in its memory, and compare the number of stored challenge strings with a threshold. If the number of challenge strings stored on the POS device 302 is lower than the threshold amount, then a request for additional challenge strings is prepared at 308 for transmission to the server 304. The POS device 302 may send an authentication message to the server 304 (to authenticate the identity of the POS device 302), receive a success or failure message from the server 304 in return, and if authenticated, may send the request for additional challenge strings to the server 304.

The server 304 generates the number of additional challenge strings requested by the POS device 302 at 310, and associates the generated challenge strings with the POS device 302 at 312. The challenge strings may each be formatted as a sequence of random bits. In some instances, the challenge strings are base64 encoded. The server 304 may uniquely associate the new challenge strings with the POS device 302, such that they may only be used by the particular POS device 302 to authenticate a user device. For instance, if a challenge string is issued to the POS device 302 and associated with the POS device, any request for authentication of a signed challenge string may return a failure if the challenge string being authenticated was not sent to the server 304 for authentication by the POS device 302 (since it may not have been issued by the POS device 302). In addition, in some cases, the server 304 may associate the new challenge strings with a particular sequence, such that they are to be issued by the POS device 302 in a particular order. For instance, any request for authentication of a signed challenge string may return a failure if the challenge string being authenticated was not issued by the POS device 302 in the correct order (potentially indicating a security breach). The server 304 then sends the new challenge strings to the POS device 302, and the POS device 302 stores the new challenge strings for later use.

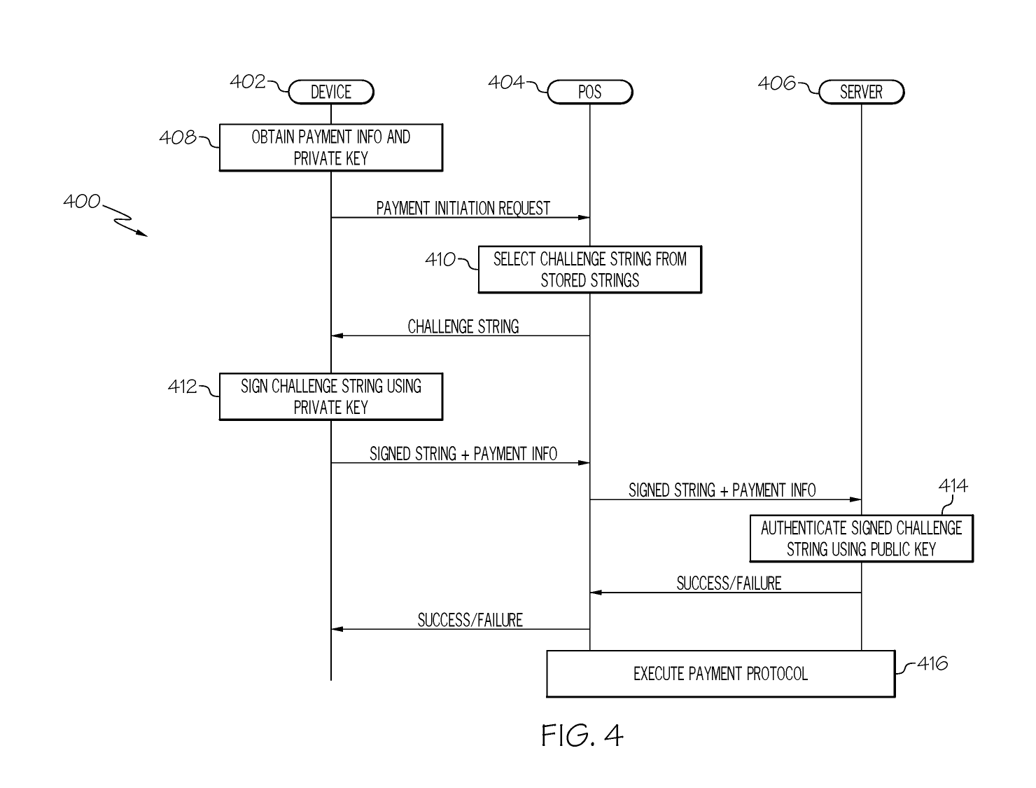

FIG. 4 illustrates an example signaling sequence 400 for performing user authentication based on challenge strings. The example sequence 400 involves a user device 402, a POS device 404, and a server 406. The user device 402 may be any type of device that can initiate transactions with the POS device 404. For instance, the user device 402 may be a smartphone (like user device 104 of FIG. 1A), a wearable device, a tablet device, or another type of mobile computing device. The POS device 404 may be any type of device that can process payment initiation requests from the user device 402 and execute transactions based on the payment initiation requests. The POS device 404 may be implemented similar to the POS device 106 of FIGS. 1A-1B. The server 406 may be an authentication server, such as the authentication server 110 of FIG. 1A, or another type of server. The sequence 400 may include additional or fewer operations than those shown in FIG. 4, and may involve additional devices or servers as appropriate. In some instances, aspects of the sequence 400 may be in accordance with the FIDO protocol (e.g., obtaining the private key or accessing the private key to sign the challenge string).

In the example shown, the user device 402 obtains payment information and a private key at 408. The payment information may include bank account, credit card, or another type of information used to process a payment transaction, and may be obtained from a user of user device 402. The private key may be associated with the payment information, and may be obtained through a registration process. The registration process may be based on the FIDO protocol. In some instances, the user device 402 may obtain the payment information or private key according to the sequence 200 of FIG. 2. For example, the user device 402 may register payment information (entered by or otherwise obtained from a user of the user device 402) with a server, and may generate a public/private key pair for association with the payment information. The user device 402 may store the private key, and associate it with the payment information.

To initiate a payment request, the device 402 sends a payment initiation request to the POS device 404. The request may be formatted in any suitable manner. The POS device 404 selects a challenge string from a set of challenge strings stored on the POS device 404 at 410, and sends the selected challenge string to the user device 402. The user device 402 signs the challenge string using the private key at 412, and sends a signed version of the challenge string to the POS device 404 along with the payment information. The user device 402 may generate the signed version of the challenge string based on encrypting or digitally signing the challenge string sent by the POS device 404 using the private key.

The POS device 404 then sends the signed version of the challenge string and the payment information to the server 406 for authentication. The server 406 authenticates the signed version of the challenge string at 414, using a public key associated with the private key used by the user device 402 to sign the challenge string issued by the POS device 404. For example, the server 406 may decrypt the signed version of the challenge string using the public key. The server 406 may then compare the decrypted challenge string with a challenge string associated with the POS device 404 to authenticate the challenge string and user device 402. In some instances, the server 406 may determine whether the challenge string is associated with the POS device 404. In addition, in some instances, the server 406 may determine whether the challenge string was issued by the POS device 404 in a previously determined sequence. The server 406 returns a success or failure message to the POS device 404, depending on the result of the authentication process at 414.

If the signed version of the challenge string is authenticated by the server 406, then a payment protocol may be executed at 416. The payment protocol may be executed by the POS device 404, the server 406, both, or in conjunction with another device or server (e.g., a payment authentication server). In some instances, execution of the payment protocol includes verifying the payment information provided by the user device 402. For example, the server 406, or another server device, may verify whether a payment method indicated in the payment information contains a sufficient amount of funds or available credit for a transaction amount indicated by the payment information.

FIG. 5 is a flowchart illustrating an example process 500 for signing a challenge string issued by a POS device. Operations in the example process 500 may be performed by components of a user device (e.g., the user device 104 of FIG. 1A). The example process 500 may include additional or different operations, and the operations may be performed in the order shown or in another order. In some cases, one or more of the operations shown in FIG. 5 are implemented as processes that include multiple operations, sub-processes, or other types of routines. In some cases, operations can be combined, performed in another order, performed in parallel, iterated, or otherwise repeated or performed another manner.

At 502, a payment initiation request is sent to a POS device. The payment initiation request may be formatted in any suitable manner, and may be sent in any suitable manner. In some cases, for example, the payment initiation request is sent to the POS device by a user device over a NFC communication channel. The payment initiation request may include a request to provide payment for a transaction registered at the POS device.

At 504, a challenge string is received. The challenge string may be sent by the POS device based on or in response to receiving the payment initiation request sent at 502. The challenge string may be formatted in any suitable manner. For example, the challenge string may be a sequence of random bits. The challenge string may be base64 encoded.

At 506, a user is prompted for an authenticator. The prompt may be presented in a graphical user interface of a user device, and may request one or more of a biometric, a personal identification number (PIN), or password. The type of authenticator that the user is prompted for may depend on a payment method that is selected by a user of the user device.

At 508, biometric information is obtained. The biometric information may be obtained in response to the prompt presented at 506. The biometric information may be collected by a component of a user device. For example, the biometric information may include a fingerprint obtained by a fingerprint reader in response to the prompt at 506.

At 510, it is determined whether the biometric information obtained at 508 is valid. In some instances, verifying whether the biometric information is valid includes comparing the biometric obtained at 508 with biometric information stored on a user device. For example, where the biometric information obtained is a fingerprint, one or more points or curves of the fingerprint obtained at 508 may be compared with points or curves of a fingerprint obtained and stored during a registration process (e.g., according to the sequence 200 of FIG. 2.).

If the biometric information is not validated at 510, a failure is returned at 511. Returning a failure may include generating a message on the user device indicating a mismatch of the biometric obtained at 508. In some instances, a user of the user device may be prompted to re-enter their biometric in response to a failure.

If the biometric information is validated at 510, then the challenge string received at 504 is signed at 512 using a private key, and the signed version of the challenge string generated at 512 is sent to the POS device at 514. Payment information to be used in the transaction may also be sent at 514. In some instances, the signed version of the challenge string and the payment information are sent together (e.g., in the same message). In other instances, the signed version of the challenge string and the payment information are sent separately. In some cases, the payment information may be sent with the payment initiation request at 502 instead of at 514. The payment information may be sent at another point in time.

FIG. 6 is a flowchart illustrating an example process 600 for performing a transaction at a POS device based on challenge strings. Operations in the example process 600 may be performed by components of a POS device (e.g., the POS device 106 of FIGS. 1A-1B). The example process 600 may include additional or different operations, and the operations may be performed in the order shown or in another order. In some cases, one or more of the operations shown in FIG. 6 are implemented as processes that include multiple operations, sub-processes, or other types of routines. In some cases, operations can be combined, performed in another order, performed in parallel, iterated, or otherwise repeated or performed another manner.

At 602, a payment initiation request is received from a user device. The payment initiation request may be formatted in any suitable manner. In some cases, the payment initiation request is received over a NFC communication channel. The payment initiation request may include a request to provide payment for a transaction that is registered at the POS device.

At 604, a challenge string is sent to the user device in response to the payment initiation request received at 602. The challenge string may be a sequence of random bits, and may be base64 encoded in some instances. Sending the challenge string may include selecting a challenge string of a set of challenge strings stored on a POS device. For example, the POS device may have a plurality of challenge strings, with the challenge strings being indicated to issue in a particular predetermined sequence. Issuing the challenge string to the user device may include selecting the next challenge in the predetermined sequence. In some embodiments, the POS device may delete the challenge string from the set of challenge strings stored thereon after sending the challenge string to the user device.

At 606, a signed version of the challenge string is received from the user device along with payment information. The signed version of the challenge string may be a signed version of a challenge string sent to the user device at 604. The signed version of the challenge string may be an encrypted or digitally signed version of the challenge string sent at 604. The signed version of the challenge string and the payment information may be received at the same time (e.g., in the same message) or separately from one another.

At 608, the signed version of the challenge string is transmitted to a server for authentication along with the payment information. In some cases, this may include generating an ISO 8583 packet that includes the signed version of the challenge string and the payment information. The ISO 8583 packet may include additional information as well, such as an identifier of the user device, an identifier of the POS device, or other information associated with the transaction (e.g., a transaction amount). The signed version of the challenge string may be transmitted to the server over a network similar to the network 108 of FIG. 1A.

At 610, the POS device receives an indication of whether the signed challenge string was authenticated by the server. The indication of whether the user device is authenticated may be based on authentication of the signed version of the challenge string by an authentication server implemented similar to the authentication server 110 of FIGS. 1A-1B. The authentication may be based on a public key associated with a private key used to sign the challenge string received at 606 (e.g., as described below).

If the signed challenge string is not authenticated by the server at 612, then a failure is returned at 614. Returning a failure may include sending a message to the user device indicating that the user device was not properly authenticated. The message may include a prompt for the user device to retry the authentication process. If the signed challenge string was authenticated by the server at 612, then a payment protocol is executed at 616 using the payment information. In some embodiments, executing the payment protocol may include validating funds associated with the payment information provided by the user device. For example, the payment information may be transmitted to a server (the same or different server than the one indicated at 608), and the server may validate the funds associated with the payment information.

In some embodiments, after transmitting the challenge string to the user device at 604, the POS device may determine the number of remaining challenge strings stored thereon at 618. If the number is less than a threshold amount at 620, then a request for additional challenge strings is transmitted to a server at 622. The request may include a request for a particular number of challenge strings. At 624, new challenge strings are received in response to the request sent at 622 and the challenge strings are stored on the POS device at 626. If the number is above the threshold value at 620, then no additional action may be taken and the process may continue to 606.

FIG. 7 is a flowchart illustrating an example process 700 for authenticating a user based on signed challenge strings. Operations in the example process 700 may be performed by components of a server device (e.g., the authentication server 110 of FIG. 1A). The example process 700 may include additional or different operations, and the operations may be performed in the order shown or in another order. In some cases, one or more of the operations shown in FIG. 7 are implemented as processes that include multiple operations, sub-processes, or other types of routines. In some cases, operations can be combined, performed in another order, performed in parallel, iterated, or otherwise repeated or performed another manner.

At 702, a signed version of a challenge string is received from a POS device along with payment information. The signed version of the challenge string may be a signed version of a challenge string issued by the POS device to a user device (e.g., as described above). The signed version of the challenge string may be an encrypted or digitally signed version of the challenge string issued by the POS device. The signed version of the challenge string and the payment information may be received at the same time (e.g., in the same message) or separately from one another.

At 704, the signed version of the challenge string is authenticated using a public key associated with the user device that signed the challenge string received at 702. Authenticating the signed version of the challenge string may include decrypting the signed version of the challenge string using the public key, or verifying a digital signature associated with the signed version of the challenge string. Authentication may also include comparing the string obtained from decrypting the signed version of the challenge string with a set of challenge strings associated with the POS device that sent the signed version of the challenge string at 702. In some instances, authentication may further include determining whether the challenge string was issued in a correct order according to a predetermined sequence of challenge strings.

If the signed challenge string is not authenticated at 706, then a failure is returned to the POS device at 707. Returning a failure may include sending a message to the POS device indicating the authentication failure. If the signed challenge string is authenticated at 706, then a payment protocol is executed at 708 using the payment information received at 702. In some instances, executing the payment protocol may include validating funds associated with the payment information received at 702. In some instances, executing the payment protocol may include transmitting the payment information received at 702 to another server or device, which may validate funds associated with the payment information.

It should be appreciated that the flowcharts and block diagrams in the figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order or alternative orders, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as suited to the particular use contemplated.

1. A method comprising:
receiving, at a point of sale (POS) device, a payment initiation request from a user device;
transmitting, from the POS device to the user device, a particular one of a plurality of challenge strings stored at the POS device based on the payment initiation request;
receiving, at the POS device, payment information and a signed version of the particular challenge string from the user device, wherein the signed version of the particular challenge string is based on a private key associated with the user device and the particular challenge string;
transmitting an authentication request from the POS device to a server device, the authentication request comprising the signed version of the particular challenge string;
receiving, at the POS device from the server device, an indication of whether the user device is authenticated based on the authentication request; and
executing a payment protocol using the payment information based on authentication of the user device.

2. The method of claim 1, further comprising:
determining that the plurality of challenge strings comprises a number of challenge strings stored at the POS device;
comparing the number of stored challenge strings with a threshold; and
based on the comparison, sending a string request to the server device for additional challenge strings.

3. The method of claim 2, further comprising:
receiving the additional challenge strings from the server device based on the string request; and
storing the additional challenge strings at the POS device.

4. The method of claim 1, wherein the particular challenge string comprises a sequence of random bits.

5. The method of claim 4, wherein the particular challenge string is base64 encoded.

6. The method of claim 1, wherein the signed version of the particular challenge string is based on encrypting the particular challenge string using the private key.

7. The method of claim 1, wherein transmission of the particular challenge string to the user device is based on a Fast Identity Online (FIDO) protocol.

8. The method of claim 1, wherein the signed version of the particular challenge string is received from the user device after a biometric is input to the user device.

9. The method of claim 1, further comprising transmitting the payment information from the POS device to the server device with the signed version of the particular challenged string.

10. The method of claim 1, wherein transmitting the signed version of the particular challenge string from the POS device to the server device comprises generating an ISO 8583 packet comprising the signed version of the challenge string.

11. The method of claim 1, wherein the indication of whether the user device is authenticated is received based on authentication of the signed version of the challenge string by the server device using a public key associated with the private key.

12. The method of claim 1, wherein each of the plurality of challenge strings is uniquely associated with the POS device.

13. The method of claim 1, wherein the plurality of challenge strings are to be transmitted in a predetermined sequence.

14. A non-transitory computer readable medium having program instructions stored therein, wherein the program instructions are executable by a computer system to perform operations comprising:
detecting a payment initiation request sent by a user device;
providing a challenge string for transmission to the user device based on the payment initiation request;
processing a signed challenge string sent by the user device, wherein the signed challenge string is generated from encryption of the challenge string with a private key;
authenticating the signed challenge string based on information from a server device; and
initiating a payment based on authentication of the signed challenge string and payment information obtained from the user device.

15. The non-transitory computer readable medium of claim 14, wherein the challenge string is a base64 encoded sequence of random bits.

16. The non-transitory computer readable medium of claim 14, wherein the operations further comprise:
processing the signed challenge string by providing the signed challenge string for transmission to the server device; and
authenticating the signed challenge string by processing a message sent by the server device indicating whether the server device authenticated the signed challenge string.

17. The non-transitory computer readable medium of claim 14, wherein the operations further comprise providing the challenge string for transmission to the user device based on a Fast Identity Online (FIDO) protocol.

18. A system comprising:
a data processing apparatus;
a memory; and
a payment execution engine, executable by the data processing apparatus to:
obtain a payment initiation request sent by a user device;
provide a challenge string for transmission to the user device in response to the payment initiation request;
obtain a signed challenge string sent by the user device, wherein the signed challenge string is generated using a private key associated with the user device and the challenge string;
transmit an authentication request to a server device, the authentication request comprising the signed challenge string;
receive, from the server device, an indication of whether the user device is authenticated based on the authentication request; and
execute a payment protocol using payment information obtained from the user device based on authentication of the user device.

19. The system of claim 18, wherein the payment execution engine is further executable by the data processing apparatus to:
obtain the additional challenge strings from the server device based on the authentication request; and
store the additional challenge strings in the memory.

20. The system of claim 18, further comprising a near field communication (NFC) interface to transmit the challenge string to the user device.
